(19) United States
(12) Patent Application Publication
(10) Pub. No.: US 2006/0265435 A1
(43) Pub. Date: Nov. 23, 2006

(54) Methods and systems for locating previously consumed information item through journal entries with attention and activation

(76) Inventor: Mikhail Denissov, Mississauga (CA)

Correspondence Address: Stephen B. Salai, Esq.;Harter, Secrest & Emery LLP, 1600 Bausch & Lomb Place, Rochester, NY, 14604-2711, US

(21) Appl. No.: 11/131,998

(22) Filed: May 18, 2005

(51) Int. Cl. G06F 17/30

(52) U.S. Cl. 707/204

(57) ABSTRACT

The present invention relates generally to personal information management methods and systems. More specifically, the present invention is related to a system and method for collecting and managing user consumed information items in the form of journal entries by monitoring the user's attention strength, recording activation of said consumed information items, and an information retrieval system and method providing search results as a combination of journal entries and retrieved information items from local search engines.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates generally to personal information management methods and systems. More specifically, the present invention is related to a system and method for collecting and managing user consumed information items in the form of journal entries by monitoring the user's attention strength, and an information retrieval system and method providing search results as a combination of journal entries and retrieved information items from local search engines.

b 2. Description of Related Art

Not applicable.

### BRIEF SUMMARY OF THE INVENTION

The present invention relates generally to personal information management methods and systems. More specifically, the present invention is related to a system and method for collecting and managing user consumed information items in the form of journal entries by monitoring the user's attention strength toward the said items, and an information retrieval system and method providing search results as a combination of journal entries and retrieved information items from local search engines.

The objective of the present invention is to provide a method to monitor and to keep track of user's attention and activation toward information items automatically, and to provide a combined personal journal of different types of consumed information items, and the ability to retrieve these journal items effectively in relation to an information item of interest. Another objective of the present invention is to generate effective memory cues to search for journal entries in order to locate usage patterns through journal entries of information consumption.

According to one aspect of the invention, it provides a computer implemented method for locating previously consumed information items by a user, comprising steps of: (i) monitoring and measuring said user's attention strength on each of information items; (ii) generating journal entries capturing events based on said user's attention strength of said user; (iii) measuring activation of information item over time; (iv) storing said journal entries in a storage means, wherein each of said journal entries is associated with said information items; (v) storing said activation of said information item in said storage means and (vi) retrieving one or more information items that matches search criteria.

According to another aspect of the invention, it provides a system for locating previously consumed information items by a user comprising: (i) a means for monitoring said user's attention strength to each of information items; (ii) a processing means for generating a journal entries of said user's attention strength to each of said information items, and for measuring activation of information item over time; (iii) a storage means for storing said journal entries and said activation of said information items; and (iv) said processing means for searching and retrieving said journal entries based on search criteria.

### BRIEF DESCRIPTION OF THE SEVERAL VIEWS OF THE DRAWING(S)

The invention will now be described in more detail with reference to the accompanying drawings, in which:

FIG. 1 illustrates a system process flow within a preferred embodiment of the present invention;

FIG. 2 illustrates an overview of the combined journal and local search capability within the present invention;

FIG. 3 illustrates an example of a simple date search of journal entries;

FIG. 4 illustrates an example of the use of an information item as memory cue to search an information item of interest through co-occurrences in time;

FIG. 5 illustrates an example of the use of a specific property of an information item, the amount of attention at each instance the said item was consumed;

FIG. 6 illustrates an example of a search result using metadata as search criteria;

FIG. 7 illustrates an example of the process flow when the user enters “hypertension” as search cues; and

FIGS. 8a and 8b illustrate how activation can be used as filter to manage the journal data.

### DETAILED DESCRIPTION OF THE INVENTION

The present invention is illustrated within a preferred embodiment to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments illustrated but is to be accorded the widest scope consistent with the principles and features described herein.

Personal computerized systems have become an integral part of workplace tools and personal information management systems at homes. The information items consumed within these systems reflect the interests of the users, and are essentially becoming an extended memory of the users. As availability of various kinds of information increased drastically with the advance of Internet/pervasive computer technology, the amount of information that each of the users consumes everyday has accordingly become enormously large. Managing and retrieving such information have become increasing needs for many people.

Various local search tools had sprung up to facilitate retrieval of essential and relevant items, and separate information management applications providing management and retrieval on particular information types, such as e-mails and web pages, have become popular. However, none of these tools provide ways to recall items based on system wide journal entries of the consumed information items.

The way to recall consumed information items of a user within a personal computer system is commonly done through keyword based search engines, which has indexed the information items or documents within the system. Such mechanism is not very useful when user needs to recall an item constitutes common keywords. For example, a user who is a marketing professional may work on a marketing research document concerning the Microsoft Company for a period of time; a few weeks after the document is completed, the user may be moving into researching other companies and has forgotten where the latest version of the document on Microsoft is located. If desktop search on the keyword “Microsoft” is performed, the user is likely to retrieve hundreds of irrelevant items, since the word “Microsoft” existed in an abundance of documents within the computer system and had been indexed by services of the local search engine. However, if there is an automated journal entry with attention and activation data recording of all the documents or information items the user has used, the document could easily be retrieved based on exact or approximate date the document has been consumed. Alternatively, the said user can search with keyword “Microsoft” ranking by amount of attention and activation of the information items and obtain relevant retrievals.

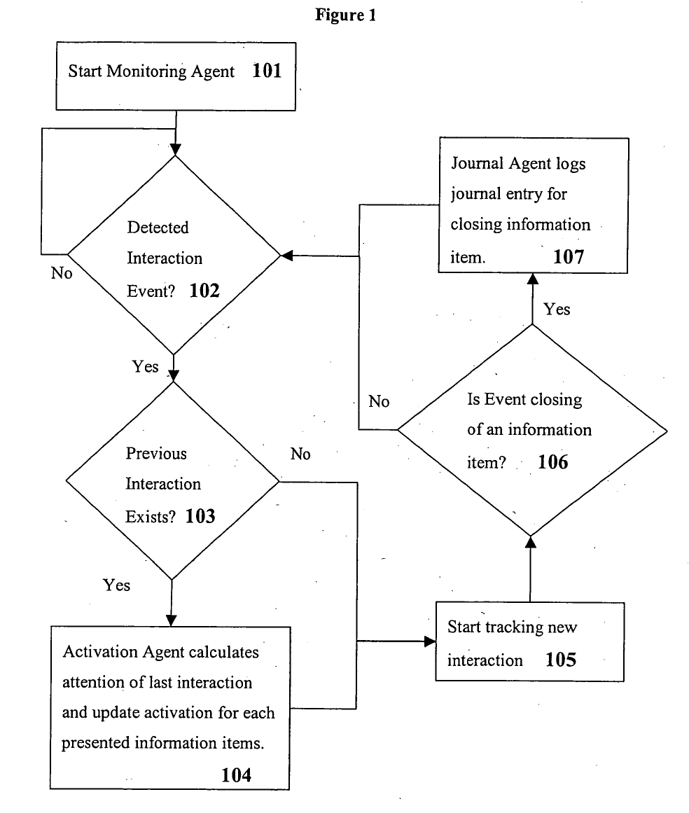

FIG. 1 illustrates monitoring and tracking interaction events in the present invention within a preferred embodiment. The events signifying start of an interaction includes, without limitation, openings/closing/focusing/de-focusing/input of information items by a specific user. The monitoring agent 101 continuously monitors all aforementioned events 102 among concurrently presented information items. The monitoring agent 101 can be a user attention tracking device or a computer executable program executed on a processing means (such as a CPU on a personal computer) that monitors its inputs (i.e. keyboard, mouse, etc) and outputs (display, speakers, etc) to track the user's attention. In the preferred embodiment of this invention, the monitoring agent 101 is the computer executable program residing in a processing means. The information items include, but not limited to, e-mails, web pages, and user application files such as Microsoft Word, Excel, Access, and PowerPoint files. Other examples of information items are multimedia files, such as MP3, MPEG4, JPEG, etc. Once detecting an event of interaction, the monitoring agent checks whether previous interaction exists 103. If previous interaction exists the monitoring agent measures the duration of the interaction period as time difference between detected events, and divides the duration of the interaction period into attention units appropriate to the corresponding presentation channel. It basically counts the number of attention units within the interaction period during which the user directed attention towards the information items proactively and counts the number of attention units within the interaction period during which said user directed attention towards the information items passively. Then, it allocates the attention units of the proactive interaction to the target information items and the attention units of the passive interaction among said target information items and all of the rest of the presented information items in the presentation channel, based on the presentation characteristics of each of said information items in said presentation channel. The calculated attention strength is then passed to the activation agent 104 for recording of attention and updating activation for each of said information items in a storage means. The storage means can be a locally or remotely mounted large capacity memory device, database or any structural storage means. In the course of no previous interaction exists, or after previous interaction has been processed in aforementioned steps, the monitoring agent starts tracking of the new interaction 105. If the detected event is closing of an information item 106, then journal agent is informed and will log journal entry for the said information item 107. Note that the event signifies the end of an interaction period does not necessarily have to be an information-consumption terminating event such as closing a document.

The aforementioned journal entry and activation recording system containing records of all consumed items provides an information management mechanism in the aspect of time and past usefulness. It is very common for a user to forget the specifics of an item of interest, such as the title or unique keywords of contents, yet remember the date the item was visited.

The attentions of a user towards presented information items are serialized events across time. In other words, when two documents are concurrently presented, the user can only focus on one specific document at a specific time. Therefore the measurement of attention is achieved by monitoring the occurrences of events that provide an indication of attention (or absence of attention) and the time lag between such events. Examples of such attention-related events include, without limitation, detectable events such as the change in size of information items, rates of change of information items, user inputs via input devices, activation of screen savers, etc. The lag times are small time gaps between events that can be regarded as part of the continuum of the occurred events, such as the lag time between keystrokes in a keyboard input process. When the time between events is greater than a pre-selected lag threshold, a time gap between events is said to have occurred. The occurrence of such attention-related events can be modeled, for either typical humans or specific users, using a probability density function, with the function chosen depending on the characteristics of presentation within a particular presentation channel, as well as the methods of user interactions with the presentation channel.

Presentation channel includes any channel by which an information item can be presented for consumption by a user, and includes, but not limited to, any visual, audio and/or any other sensing channel. For example, in a preferred embodiment employing a visual presentation channel, the attention-related events are considered to have equal weights, and so a probability density function with a lognormal distribution would be chosen. However, in a system featuring events that differ from each other in the degree to which they can draw attention, the events are not equally weighted and two or more lognormal distributions, or other probability density functions may be employed. In either case, when the probability density of events drops below a certain threshold, it can be assumed that user is no longer paying attention. The aforementioned attention measurement plays an important role in measuring the activation of an information item.

In a preferred embodiment of the present invention, the base activation of presented information items is measured and updated whenever new attention-related events occur; where “base activation” or “base level activation” means activation determined solely by the frequency, duration and recency of use of an information item, thereby quantifying the general past usefulness of the information item and providing a general context-independent estimation of how likely the information item is to be useful, and “base activation of an interaction” means an instance of practice of an information item, and includes, without limitation, both base activation arising from the presentation of the information item and/or from actual user interaction with the information item. The time elapsed since the previous event occurred contains a number of evenly spaced time slots, hereinafter called attention units. In a visual presentation channel without external attention-tracking devices, the attention unit is the eye-fixation time in biological band, ranging from 200-400 milliseconds, which models the amount of time that it takes a human to fix an eye on an information item depending on the complexity of the presented item and the characteristics of the user. The determination of the amount of attention units can be further calibrated through software applications. When eye-tracking devices are available, the eye fixation and saccades statistics will provide more precise measurement of attention units. The number of attention units received by an information item within the period of consumption represents its strength of activation during the consumption.

When the base activation of the presented information items is updated, the attention units are distributed to the presented information items according to their occupancy percentage of space within the presentation channel(s). However, this distribution does not always correspond to the perceived occupancy of the items within the presentation channel. For example, if an item has the full attention of a user (which can be assumed from some form of user interaction with the item such as keyboard entries), the said item will logically occupy 100% of the presentation space as far as the user is concerned and so the number of attention units allocated to the item will reflect that. In the scenario when no user activities are detected, the presentation characteristics of the items will depend on their characteristics within the presentation channel. In a visual channel, such characteristics could include for example, relative size and color contrast, animation, and distance of items from the previous item that enjoyed full user attention, to name a few, and such characteristics will all contribute to the number of attention units allocated to each item. Finally, as stated above, when the absence of attention-related activities is detected based on pre-defined thresholds, the absence of attention is assumed.

It should be noted that the same principles could be applied to other presentation channels. For example, in an audio channel, attention units could be represented by the smallest note length perceptible by humans, i.e., approximately 1/128 second, or one or more multiples of the said note length whenever applicable, whereas presentation characteristics can be related to audio signal volumes, frequencies, loudness (perceived volume), pitch (perceived frequency) and other psychoacoustic parameters of such signals.

The decay in human memory can be modeled mathematically by decreasing negatively accelerating functions such as power and exponential functions. The present invention employs the power function originated in the power law of forgetting and deployed in ACT-R, a theory and related cognitive architecture for simulating and understanding human cognition, with a focus on how human knowledge is acquired and deployed, adapted to the information management context of the present invention to measure the base activation of an information item i over time in an information context. That formula is:

$${B}_{i} = ln {\sum }_{j = 1}^{n} {S}_{ij} {t}_{j}^{- d} \qquad [ 1 ]$$

where, Bᵢ is the attention or base activation of information item i gained through presentation or user activities,

Sᵢⱼ is the strength information item i at its j^{th} occurrence based on presentation characteristics or user activities,

tⱼ is the time lapsed since the j^{th} occurrence of information item i,

d is the decay parameter that simulates the process of “forgetting” in the context of information items, and

n is the number of times the information i has occurred.

Note that the strength Sᵢⱼ varies at each instant in time according to presentation characteristics or types of user activities, and is represented by the number of aforementioned attention units allocated to each information item. It should also be noted that the formula [I] captures the cumulative nature of base activation, meaning that the measurement of base activation at any instant in time according to the formula will take into account the residual activation and decay associated with previous interactions, whether those previous interactions result from user interactions with the information item or from presentation of the information item.

When attention tracking and attention/decay emulation devices are present, the cumulative attention (i.e., attention units) directed towards an information item can be precisely measured since the attention strength and decay associated with individual attention units can be accurately tracked and allocated to information items. However, in a preferred embodiment without the aforementioned devices, the attention of each interaction period is measured as groups of attention units being distributed among presented items. The said interaction period begins with a noticeable event signifying the beginning of attention (such as opening an item or resuming attention), to another noticeable events signifying the end of attention (such as closing an item or absence of attention detected).

The present invention distributes attention units to concurrently presented information items based on the detection of user activities and presentation characteristics of the said items. For example, if any targeted user activities towards an information item such as inputs are detected, the information item is said to have the undivided attention of user and the strength (S) is equal to sum of all attention units within the period of interaction. In other words, the rest of the concurrently presented information items will receive zero attention during the user's proactive interaction with the information item and hence will not receive any allocation of attention units. In the absence of user activities (or during the user's passive interaction with information items), attention units will be allocated to presented information items using probability-based statistical techniques for predicting user eye-fixation, or other such perceptual cues as measures of attention. In a preferred embodiment, the present invention assumes that user attention to each presented information item is proportional to the space occupied by the item within the presentation channel, hereinafter referred as occupancy percentage. However, as aforementioned, the occupancy percentage does not relate only to physical dimensions, but also depends on the presentation characteristics of the said item, including without limitation, any event such as rate of change of presentation, presence or addition of sound, static and dynamic graphical elements, the amount of time elapsed since the previous focused user activity, the distance from the identified information item of most recent focus, etc. In other words, the occupancy percentage of an information item is directly proportional to the ability of the item to draw attention. Various other modeling techniques can be used by those skilled in the art to take such additional complexity into account. When the total number of presented items competing for attention in the same presentation channel(s) exceeds a threshold, the items with relatively less ability to draw attentions may not receive any attention units, simulating information overloading. In this regard it should be noted that research has shown that typical humans can only pay attention to no more than five to seven items concurrently, so when more than seven information items are presented concurrently, the items with occupancy percentages less than the 7^{th} lowest item will not receive any attention.

The measurement of user's attention strength toward an information item is based upon the detection of user-active events (or user's proactive interaction with the information item) such that said information item gains the undivided attention of the user. For example, when the user's proactive interaction tasks associated with a computer system, such as keyboard input, mouse actions to highlight, cut and paste, or other proactive interactions from devices such as digital pens, game controllers, etc. are performed on a presented information item, the said information item can be said to have the undivided attention of the user.

The detection of user-active events should take into consideration the lag time in between detectable events. However, during any periods when a threshold in lag time indicating a lack of attention is exceeded, the user's attention strength would be measured with reference to presentation channel characteristics and the manner in which the information item is situated within that channel, instead of with reference to actual user interaction. The lag time threshold can be established in various ways. For example, in the case of the typing, the lag time threshold could either be a fixed amount of delay between keystrokes based on average users, or calibrated through apparatus or software applications to be more user-specific.

The attention that a user gives to an information item can also be measured through other kinds of attention tracking devices, ranging, without limitation, from other human observes to equipment such as eye motion tracking devices, etc.

When measuring attention based on user interactions with presented information item(s), it is also necessary to detect deliberate user absence. This condition can be measured via attention monitoring devices or through the detection of the absence of any user activities over a preset time threshold, as well as through the detection of system events such as screen saver activation within a computer.

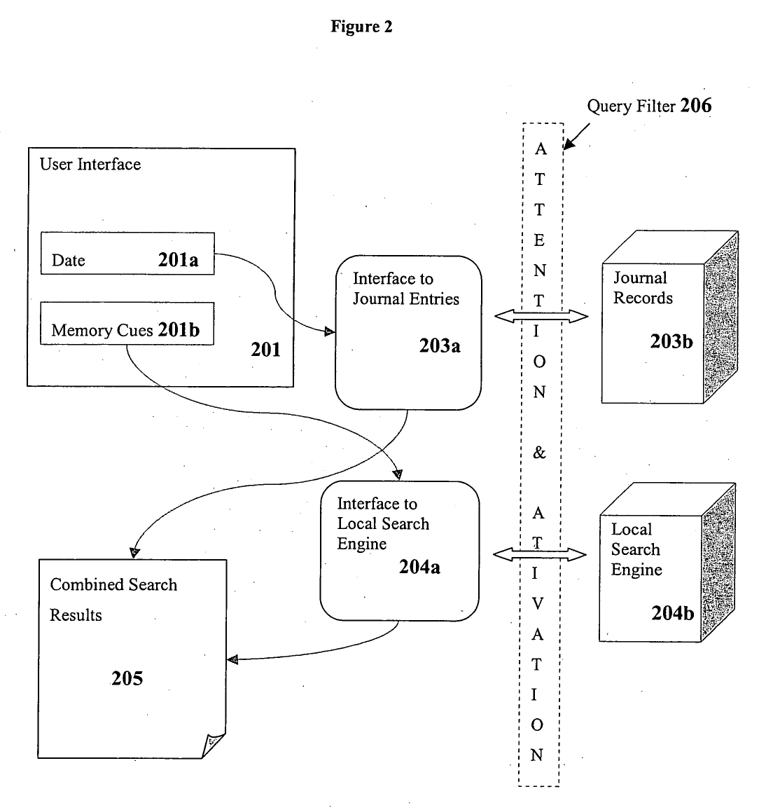

FIG. 2 illustrates the unique ability of merging search results from journal entries and from relevance search in present invention. A simple user interface 201 provides either date search 201a only, memory cues search 201b only, or a search query as combination of both. The date entry will be processed by interface to journal entries 203a to retrieve the journal records 203b on particular date or date range, and the memory cues will be passed to local search engine interface 204a, which in turn process the memory cues as search criteria to the local search engine 204b. Optionally a query filter based on attention strength threshold (or “attention strength filter”) and threshold of activation (or “activation score filter”) 206 can be applied as part of the query. The attention strength filter is used to limit the size of the search result based on amount of attention. A combined result set is returned 205. The ability to search through journal entries, keyword indexed local search engine, attention strength filter and activation score filter provides a power method to recall and manage consumed information items within a preferred embodiment.

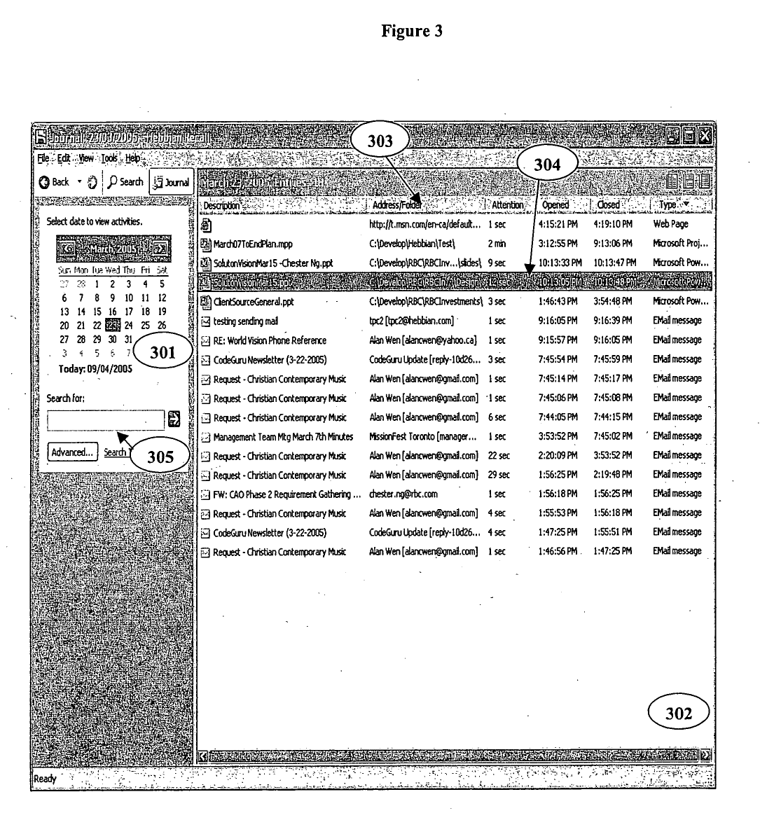

FIG. 3 illustrates a simple record look up within the system journal entry through selecting a date from the Journal. The calendar 301 illustrates an available interface for user to enter date as the search criteria for the journal records. The memory cue entry 305 is interface for the user to enter memory cue for the search. A result pane in the form of a list of journal entries 302 displays the total entry contained within the aforementioned selected date. The header of the result pane 303 serves both as data descriptor and sorting trigger which enables user to easily locate item of interest through choice of sorting column. The item of interest highlighted by the selection bar 304 can subsequently be launched for viewing or used as memory cues for either the journal entry or other search engines. In human memory, items are often recalled through associative memory, which are basically memory cues, which enhances a certain piece of memory.

Since human activities are always associated with time, the aspect of time is therefore an important memory map. For example, forgotten events are often being recalled by walking through an itinerary of activities.

The following example further demonstrates how the present invention emulates human remembering pattern with associate memory,

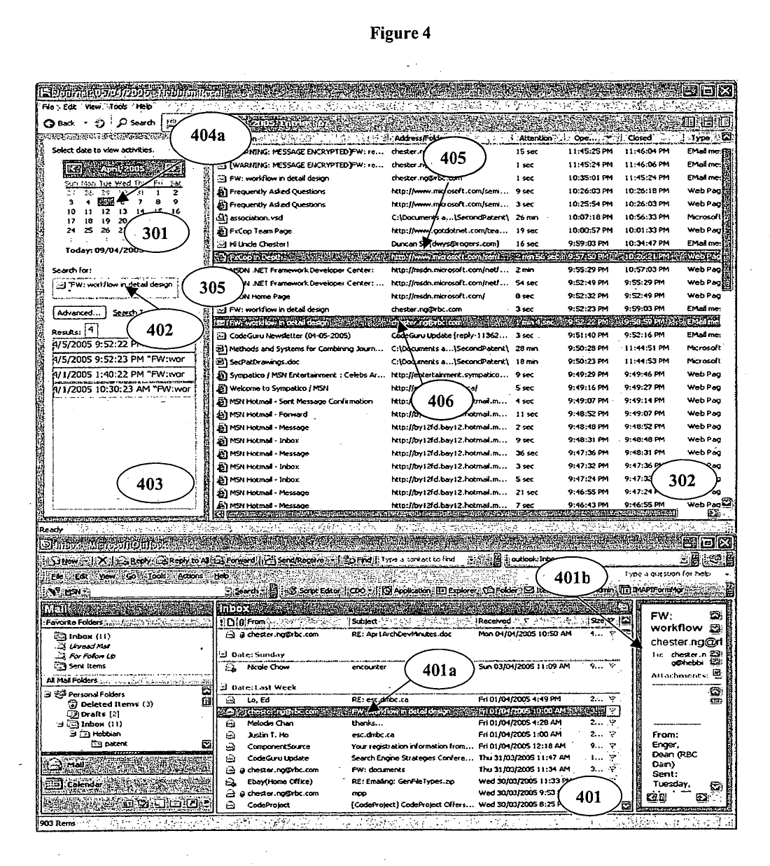

FIG. 4 illustrates the use of an information item as memory cue to look up an information item of interest through co-occurrences in time. Within this illustration, the user needs to locate some information about a development tool he has come across recently through reading some document. However, he could not remember the name of the tool, nor did he remember the information type of the document, therefore it is difficult for him to perform local search or Internet search for the item, since “development tool” as search cue will provide a lot of irrelevant items to sort through. All the user could remember was the fact that when he was exploring information about this tool, he was reading an e-mail from a friend named “Chester” 401a about “workflow in detail design” 401b. He looked up within an e-mail application, Microsoft Outlook, to locate the e-mail from Chester 401a from the message list 401. The preview of the e-mail from Chester 401b is shown in the preview pane of the Microsoft Outlook application 401b. Then, the user uses the said email item as memory cue phrase 402 in the memory cue entry 305 by dragging and dropping the item to the entry. The journal search located four occurrences of e-mails from Chester listed in the journal search list pane 403. The user interface also automatically highlights the most recent date 404a on the calendar 301. As the user looked around the e-mail from Chester 406 within the list of journal entries shown in the result pane 302 containing the memory cue (e-mail from Chester), he quickly located the journal entry indicating the web page titled “fxCop in Depth” 405, which is the article related to the development tool he was interested in. It is important to note that within this simple illustration, the user did not remember the desired information type is a web based article, nor did he remember the name of the tool is fxCop; therefore the article is retrieved entirely based on his associative memory of “reading an e-mail from Chester about workflow” 406.

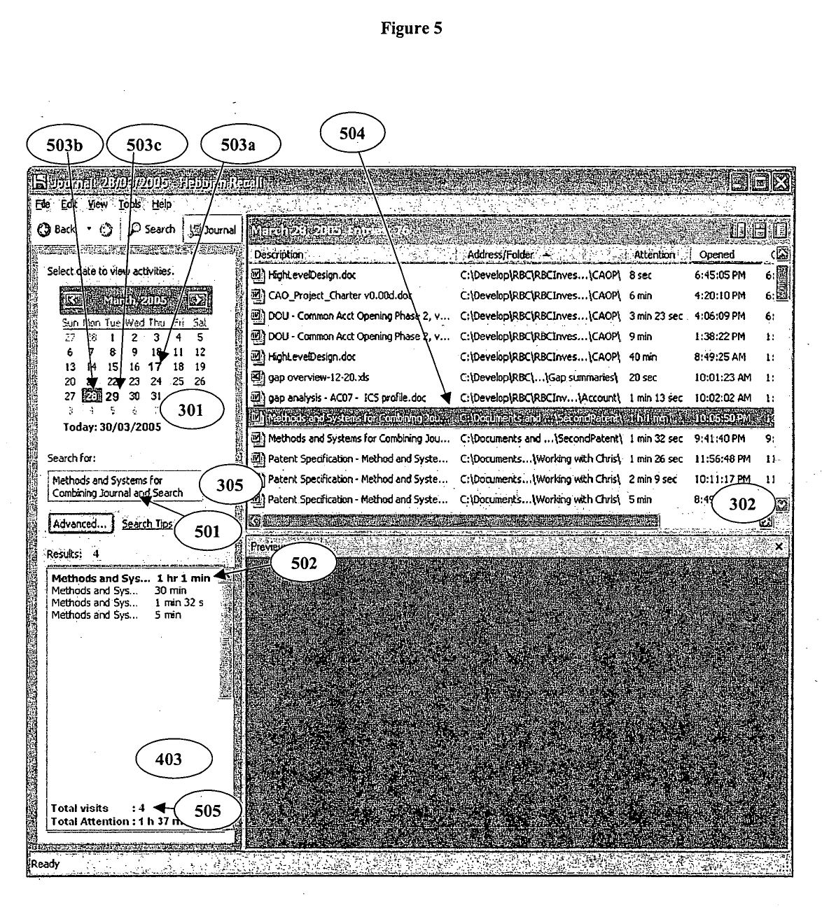

FIG. 5 illustrates the use of a specific property of the information item, the amount of attention at each instance the said item was consumed. The user wants to locate a document about “Gap Analysis” which he has not used for a while and does not remember where within the system it was located. However he remembers last time he referred to the document was when he was working on another document titled “Methods and Systems for Combining Journal and Regular Search to locate Previously Consumed Information Items”, and has spent a long time editing the said document. Therefore he needs to locate the most attentive occurrence of the aforementioned document. He used the said document as memory cue phrase 501 in the memory cue entry 305, and specified the returned results should be in descending order of the attention of the cue item, the one with the highest attention 502 being top in the list in the journal search list pane 403. The search within journal data returns four (4) occurrences 505 at various dates, namely March 17 503a, March 28 503b, and March 29 503c shown in the calendar 301, highlighted in bold. As it can be seen with the journal search result pane 403, the one with highest attention 502 is at the top of the journal search result pane 403. As soon as the user selected the highest attention occurrence of the document, he had located his “gap analysis” document, which is above the occurrence of the cue item 504. Note that in the aforementioned illustration, within the summary of the returned occurrences 505, the total amount of attention ever received by the cue item is shown. Statistic information such as number of occurrences, number of days an item is consumed and total amount of attention, etc. is byproducts of a journal entry system and is valuable indicators of productivity information.

A journal entry system tracking all consumed information items with search capability also provide other non-obvious benefits. For example, a user who reads a news site regularly will contain hundreds of cached pages within his computer system if not thousands. The fastest way to recall an interesting news article he recently read is to simply use the URL of the news site as memory cue and look up the last date of visit. If he were to use other local search engines to retrieve the news article, he would have to identify specific keywords within the article of interest as search criteria, otherwise using local search will return a lot of undesired items. When the aforementioned journal entry system is combined with a local search system, the productivity of information management can be multiplied by many folds. The present invention encumbers the aforementioned journal recording and retrieval system and a local search system. The local search system provides the means of relevance search on keywords, while the journal entry system provides the means to search for items associated with time.

The ability to quickly locate an item through journal date entries, or use an item as memory cue to reverse look up all occurrences in the dimension of time, subsequently locating associated items provides powerful tools for measuring productivity. However, there are cases users need to locate a cluster of information, and do not want to specify one single item as memory cue. For example, a user who has performed research on a certain academic subject for a few weeks will not be able to remember any details after a year has past, except the fact that he has done academic research on the aforementioned topic. How would he be able to quickly locate the cluster of activities he has performed a year ago when he could remember neither the exact time nor any of the information item identifier such as URL or filename? In the present invention which combines the ability of a local search engine and journal tracking, the user can simply use the topic of the academic subject as cue, the local search engine will process the keyword cue and returns a set of information items, which subsequently become cues for the journal tracking system and returns all the dates the items were consumed. The user could then walkthrough his own journal entries during the period of time and locates information items required or observes the research activity pattern. This type of information, when stored in Enterprise database, can provide valuable data on working pattern of the knowledge workers.

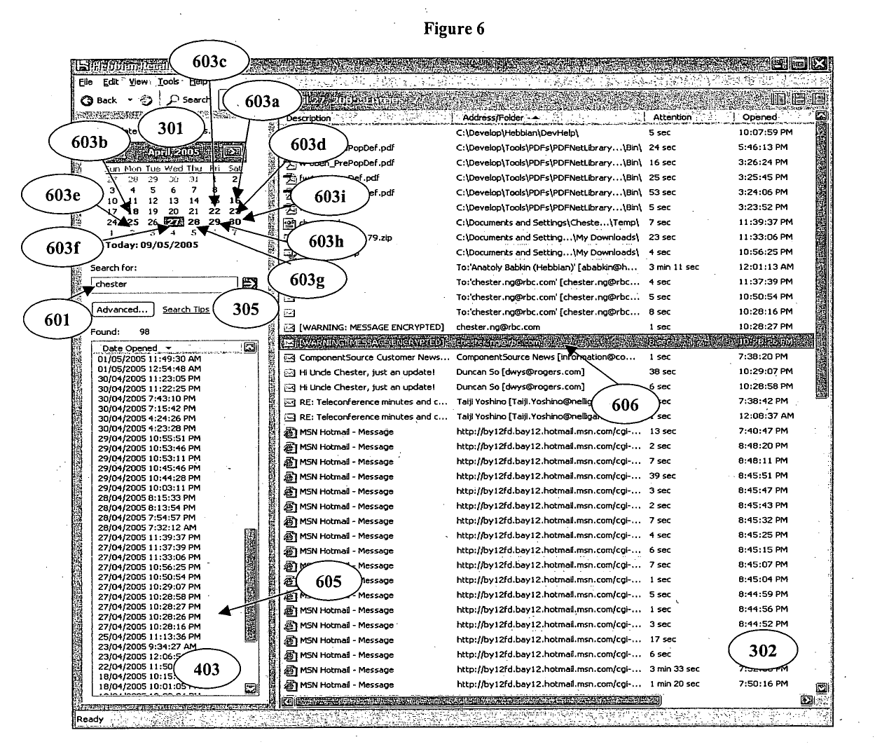

A local search engine typically only indexes the keywords from contents of information items. The present invention implements a method to capture metadata of information items and expose them as content keywords to be indexed by local search engine. FIG. 6 illustrates an exposed metadata search result. The memory cue phrase 601 specifies “chester” as a cue for the search in the memory cue entry 305, then it searches not only contents of e-mails, web pages, documents, but also the metadata in e-mails such as “from”, “to”, “subject” etc. and returns all e-mails sent by “chester”, all web pages contains the word “chester,” and all other documents contained the word “chester.” The result may be filtered by type, attention strength, time/date when the information items opened or closed. On the journal search result pane 403, a list of journal entries based on time/data when the information items opened are displayed for the user to further select., along with highlighting dates, namely “April 16” 603a, “April 18” 603b, “April 22” 603c, “April 23” 603d, “April 25” 603e, “April 27” 603f, “April 28” 603g, “April 29” 603h and “April 30” 603i in bold on the calendar 301. The user highlights one of the dates of interest 605 displayed on the journal search result pane 403, which causes the “April 27” 603f on the calendar 301 and the corresponding journal entry 606 on the list of journal entries in the result pane 302 to be highlighted. The result pane 302 displays a list of journal entries occurred proximity of the selected corresponding journal entry 606.

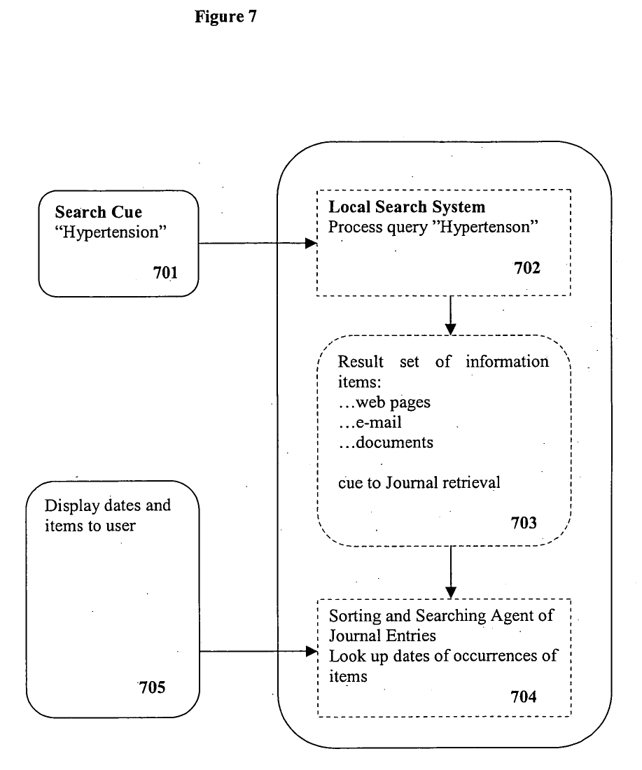

FIG. 7 illustrates the process flow of the aforementioned example. The user enters “hypertension” as search cues 701. Since the cue does not match identifier of an information item such as filename, e-mail items, web page URL etc., the present invention performs a local keyword search through the local search system 702. The local search system returns articles or documents match the search criteria 703. The returned result set from the local search system 703 are fed into Sorting and Searching Agent of journal Entries 704 as memory cues, which subsequently returns the set of dates the information items appeared and displayed to the user 705.

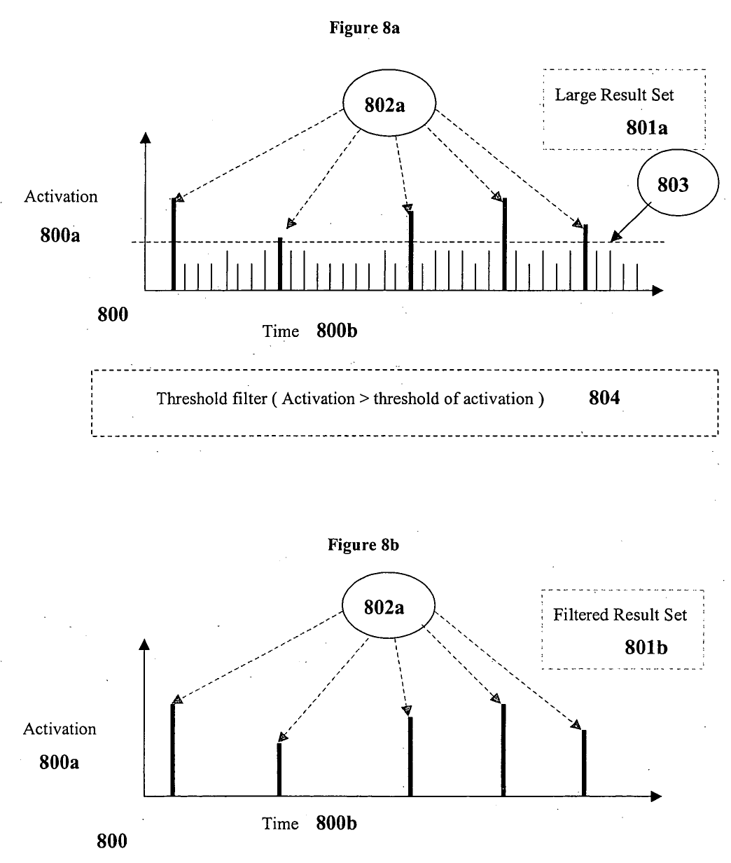

The biggest advantage of present invention lies in the ability to manage journal items. Over time as number of journal items increases, the search results will increase in number accordingly and therefore the need to go through large result sets will affect the efficiency of the whole system/method disclosed herein. FIG. 8a and 8b demonstrate how this embodiment of the present invention can filter the result sets 801a based on a threshold of activation 803. In FIG. 8a, a large result set of journal entries that matching the search criteria 801a are listed chronically in a bar graph 800, having amount of activation as Y axis 800a and time as X axis 800b. When there is a large result set matching the search criteria 801a, the threshold of activation 803 can be applied to filter the result set 801a by using a threshold filter 804. The threshold filter 804 compares each activation value of matching journal entries with the threshold of activation 803. FIG. 8b shows the filtered result set 801b after going through the threshold filter 804. In the filtered result set 801b, only the high activation information items 802a are appeared. It is essential to note that these high activation information items 802a are “well-remembered” items by the user(s). The threshold filter 804 can be specified as a part of the search criteria, as well as a selection filter for items to be retained in a storage reduction process.

Thus a method and system for locating and managing user consumed information items is disclosed. When applying present invention to the enterprise, personal data can be pooled to provide individual metrics and statistics reflecting working patterns and productivity of individuals and working groups.

It is to be understood that the embodiments and variations shown and described herein are merely illustrations of the principles of this invention and that various modifications may be implemented by those skilled in the art without departing from the spirit and scope of the invention.

1. A computer implemented method for locating previously consumed information items by a user, comprising steps of:
(i) monitoring and measuring said user's attention strength on each of information items;
(ii) generating journal entries capturing events based on the user's attention strength of said user;
(iii) measuring activation of said information items over time;
(iv) storing said journal entries in a storage means, wherein each of said journal entries is associated with said information items;
(v) storing said activation of said information item in said storage means; and
(vi) retrieving one or more information items that matches search criteria.

2. The method as recited in claim 1, wherein said attention strength is directed by said user towards one of one or more information items present in a presentation channel during an interaction period in which said user directs attention towards a target information item through one or more proactive or passive interactions with said target information item.

3. The method as recited in claim 2, wherein said measuring of said attention strength of said user comprising steps of:
(i) recording the start time of said interaction period as represented by the start of an event through which said user directs attention towards said target information item;
(ii) recording the end time of said interaction period as represented either by (a) the passage of a specified period of time during which said user does not direct any attention towards said target information item, or (b) the start of another event that confirms that said user is not directing any attention towards said target information item;
(iii) measuring the duration of said interaction period as difference between said end time and said start time of said interaction period;
(iv) dividing said duration of said interaction period into attention units appropriate to corresponding said presentation channel;
(v) counting the number of attention units within said interaction period during which said user directed attention towards said information item proactively;
(vi) counting the number of attention units within said interaction period during which said user directed attention towards the information item passively;
(vii) allocating said attention units recited in sub-step (v) to said target information item; and
(viii) allocating said attention units recited in sub-step (vi) among said target information item and all of the rest of said information items present in said presentation channel, based on the presentation characteristics of each of said information items in said presentation channel.

4. The method as recited in claim 3, wherein said confirmation of said user who is not directing any attention towards said target information item is provided by confirming by either:
(i) detecting said another event has gained undivided attention of said user;
(ii) detecting said another event caused occupancy percentage of said target information item become less than the lowest occupancy percentage of the information item that the typical humans can pay attention to; or
(iii) detecting the absence of any user activity over a predefined time threshold.

5. The method as recited in claim 3, wherein said presentation channel is either visual or auditory.

6. The method as recited in claim 5, wherein said attention unit of said visual presentation channel is predetermined in the range of 200 to 400 milliseconds.

7. The method as recited in claim 2, wherein said attention strength of said user is measured by an attention tracking device, wherein said attention tracking device is eye tracking device.

8. The method as recited in claim 5, wherein said attention unit of said auditory presentation channel is predetermined as the smallest note length perceptible by humans, wherein said attention unit is approximately 1/128 second or one or more multiple of said smallest note length.

9. The method as recited in claim 1, wherein each of said journal entries comprises a plurality of fields for storing information regarding said events, wherein said plurality of fields comprises:
(i) description of an information item that said user's attention was directed toward;
(ii) location or address of said information item;
(iii) attention strength of said user towards said information item;
(iv) date and time of said information item when opened;
(v) date and time of said information item when closed; and
(vi) type of said information items.

10. The method as recited in claim 9, wherein said location of said information items is Uniform Resource Locator, data file location or e-mail address.

11. The method as recited in claim 1, wherein said information items are user data files associated with user applications, wherein said user application comprises e-mail, Web browser, or office related application software.

12. The method as recited in claim 1, wherein said search criteria comprises:
(i) scoring information items based on one or more search terms and profile of said information items; and
(ii) ranking said information items based on said scorings of corresponding said information items.

13. The method as recited in claim 12, wherein said profile of said information item comprises name, e-mail address, URL, type of said information item, duration of user's attention toward said information item, date and time when opened, and date and time when closed.

14. The method as recited in claim 13, wherein said profile of said information item further comprises metadata or content of said information item.

15. The method as recited in claim 12, wherein said search criteria further comprises a threshold of activation.

16. The method as recited in claim 12, wherein said search criteria further comprises an attention strength threshold.

17. The method as recited in claim 1, wherein said step (i) further comprises a step of deciding whether to generate a journal entry for an event by comparing a threshold of activation with activation of said event.

18. The method as recited in claim 17, wherein said threshold of activation is configurable by said user.

19. The method as recited in claim 17, wherein said threshold of activation is predetermined.

20. The method as recited in claim 1, wherein said measuring of said activation is estimated by a mathematical modeling of base activation of said information item over time, wherein said modeling is modeling cumulative nature of base activation and the decay in human memory.

21. A system for locating previously consumed information items by a user comprising:
(i) a means for monitoring said user's attention strength to each of information items;
(ii) a processing means for generating journal entries of said user's attention strength to each of said information items and for measuring activation of said information item over time;
(iii) a storage means for storing said journal entries and said activation of said information items; and
(iv) said processing means for searching and retrieving said journal entries based on search criteria.

22. The system as recited in claim 21, wherein said attention strength is directed by said user towards one of one or more information items present in a presentation channel during an interaction period in which said user directs attention towards a target information item through one or more proactive or passive interactions with said target information item.

23. The system as recited in claim 22, wherein said measuring of said attention strength of said user comprising steps of:
(i) recording the start time of said interaction period as represented by the start of an event through which said user directs attention towards said target information item;
(ii) recording the end time of said interaction period as represented either by (a) the passage of a specified period of time during which said user does not direct any attention towards said target information item, or (b) the start of another event that confirms that said user is not directing any attention towards said target information item;
(iii) measuring the duration of said interaction period as difference between said end time and said start time of said interaction period;
(iv) dividing said duration of said interaction period into attention units appropriate to corresponding said presentation channel;
(v) counting the number of attention units within said interaction period during which said user directed attention towards said information item proactively (hereinafter called the proactive attention period);
(vi) counting the number of attention units within said interaction period during which said user directed attention towards the information passively;
(vii) allocating said attention units recited in said sub-step (v) to said target information item; and
(viii) allocating said attention units recited in said sub-step (vi) among said target information item and all of the rest of said information items present in said presentation channel, based on the presentation characteristics of each of said information items in said presentation channel.

24. The system as recited in claim 23, wherein said confirmation of said user who is not directing any attention towards said target information item is provided by confirming by either:
(i) detecting said another event has gained undivided attention of said user;
(ii) detecting said another event caused occupancy percentage of said target information item become less than the lowest occupancy percentage of the information item that the typical humans can pay attention to; or
(iii) detecting the absence of any user activity over a predefined time threshold.

25. The system as recited in claim 23, wherein said presentation channel is either visual or auditory.

26. The system as recited in claim 25, wherein said attention unit of said visual presentation channel is predetermined in the range of 200 to 400 milliseconds.

27. The system as recited in claim 21, wherein said means for monitoring said user's attention strength to each of information items is said processing means, whereins said processing means monitors its input and output to estimate and measure attention strength to each of said information items.

28. The system as recited in claim 21, wherein said means for monitoring said user's attention strength to each of information items is an attention tracking device, wherein said attention tracking device is eye tracking device.

29. The system as recited in claim 25, wherein said attention unit of said auditory presentation channel is predetermined as the smallest note length perceptible by humans, wherein said attention unit is approximately 1/128 second or one or more multiple of said smallest note length.

30. The system as recited in claim 21, wherein each of said journal entries comprises a plurality of fields for storing information regarding said events, wherein said plurality of fields comprises:
(i) description of an information item that said user's attention was directed toward;
(ii) location or address of said information item;
(iii) attention strength of said user towards said information item;
(iv) date and time of said information item when opened;
(v) date and time of said information item when closed; and
(vi) type of said information items.

31. The system as recited in claim 30, wherein said location of said information items is Uniform Resource Locator, data file location or e-mail address.

32. The system as recited in claim 21, wherein said information items are user data files associated with user applications, wherein said user application comprises e-mail, Web browser, office related application software.

33. The system as recited in claim 21, wherein said search criteria comprises:
(i) scoring information items based on one or more search terms and profile of said information items; and
(ii) ranking said information items based on said scorings of corresponding said information items.

34. The system as recited in claim 33, wherein said profile of said information item comprises name, e-mail address, URL, type of said information item, duration of user's attention toward said information item, date and time when opened, and date and time when closed.

35. The system as recited in claim 34, wherein said profile of said information item further comprises metadata or content of said information item.

36. The system as recited in claim 33, wherein said search criteria further comprises a threshold of activation.

37. The system as recited in claim 33, wherein said search criteria further comprises an attention strength threshold.

38. The system as recited in claim 21, wherein said means for generating journal entries further comprises a means of deciding whether to generate a journal entry for an event by comparing a threshold of activation with activation of said event.

39. The system as recited in claim 38, wherein said threshold of activation is configurable by said user.

40. The system as recited in claim 38, wherein said threshold of activation is predetermined.

41. The system as recited in claim 21, wherein said measuring of said activation is estimated by a mathematical modeling of base activation of said information item over time, wherein said modeling is modeling cumulative nature of base activation and the decay in human memory.
